(19) United States
(12) Patent Application Publication
(10) Pub. No.: US 2026/0286049 A1
(43) Pub. Date: Sep. 24, 2026

(54) SURFACTANTS FOR SHAPE MEMORY POLYMER FOAM SYNTHESIS

(71) Applicants: Mary Beth Monroe, Syracuse, NY (US); Natalie M. Petryk, Berkeley Heights, NJ (US)

(72) Inventors: Mary Beth Monroe, Syracuse, NY (US); Natalie M. Petryk, Berkeley Heights, NJ (US)

(73) Assignee: Syracuse University, Syracuse, NY (US)

(21) Appl. No.: 19/476,209

(22) PCT Filed: Apr. 17, 2024
(86) PCT No.: PCT/US2024/024890

§ 371 Date: Oct. 17, 2025

Related U.S. Application Data
(60) Provisional application No. 63/496,559, filed on Apr. 17, 2023.

(51) Int. Cl. C08G 65/336; C08G 65/26; C08J 9/00; C08L 75/04

(52) U.S. Cl. CPC C08G 65/336; C08G 65/2615; C08J 9/0061; C08L 75/04; C08L 2203/14

(57) ABSTRACT

A readily available and inexpensive surfactant for shape memory polymer foam formation. The surfactant is used as a pore stabilizer during polymerization in the presence of a blowing agent. The surfactant is formed by reacting a conventional surfactant having a free reactive group, such as a hydroxyl group, an amine group, or a carboxylic acid group, with an isocyanate to form a urethane, urea, or amide bond, respectively, at the location of the reactive group. An exemplary surfactant is polyethoxylated castor oil that has been reacted with 3-(triethoxysilyl)propyl isocyanate, to form macroglycerol ricinoleate urethane 3-(triethoxysilyl)propyl.

### CROSS-REFERENCE TO RELATED APPLICATION

The present application claims priority to U.S. Provisional App. No. 63/496,559 filed on Apr. 17, 2023.

### BACKGROUND

### 1. Field

The present disclosure relates to polymer foam synthesis and, more specifically, to surfactants for use in forming polyurethane foams.

### 2. Description of the Related Art

Uncontrolled bleeding is responsible for nearly 1.5 million deaths each year, with hemorrhaging the leading cause of preventable battlefield deaths. Current treatment options, such as gauze and tourniquets, are ineffective for up to eighty percent of wounds. These options are only effective in the short term and do not address non-compressible hemorrhages and can lead to tissue damage, rebleeding, and the loss of limbs. One potential solution involves the use of thermally-activated polyurethane (PUr) shape memory polymers (SMPs). A compressed foam dressing formed from such polymers can be applied to a wound and allowed to expand into a primary shape to fill a site of bleeding where the foam induces clotting, as seen in FIG. 1. Such dressings can be used for prolonged field care use for non-compressible wounds and have been demonstrated to provide reduced blood loss and improved survival in animal testing as compared to conventional approaches.

Current foam hemostatic dressings must be synthesized with surfactants, which are not readily available, thereby compromising the ability to provide such dressings in large scale quantities, such as in every first aid kit. Accordingly, there is a need in the art for surfactants that are readily available and inexpensive so that foam hemostatic dressings can be synthesized affordably and in large quantities.

### BRIEF SUMMARY

The present invention is an easily synthesized surfactant that can be formed from readily available and inexpensive components. The surfactant of the present invention can be synthesized by modifying a polyethoxylated castor oil, such as KOLLIPHOR® EL, with an isocyanate, such as 3-(triethoxysilyl)propyl isocyanate. The surfactant of the present invention is well suited for PUr foam formation, and polymer foams that are formed using the surfactant demonstrate acceptable structural, thermal, and shape memory properties as well as cytocompatibility for use as wound dressings.

In a first embodiment, the present invention may be a pore stabilizer for use in polymer foam formation that is formed from a surfactant having a free group reacted with an isocyanate to form a urethane, urea, or amide bond. The surfactant may comprise polyethoxylated ricinoleic acid triglyceride. The isocyanate may be 3-(triethoxysilyl)propyl isocyanate. The surfactant may be macroglycerol ricinoleate urethane 3-(triethoxysilyl)propyl. The free group of the surfactant may be selected from the group consisting of a hydroxyl group, an amine group, or a carboxylic acid group.

In another embodiment, the present invention is a method of forming a thermally-activated polyurethane foam, comprising the step of reacting a diisocyanate with a polyol to form a polyurethane in the presence of a blowing agent and a pore stabilizer formed from a surfactant having a free group reacted with an isocyanate to form a urethane bond.

In a further embodiment, the present invention may be a method of forming a pore stabilizer, comprising the steps of providing a surfactant having a free group and reacting the surfactant with an isocyanate to form a urethane, urea, or amide bond at the free group. The surfactant may comprise polyethoxylated ricinoleic acid triglyceride. The isocyanate may be 3-(triethoxysilyl)propyl isocyanate. The surfactant may be macroglycerol ricinoleate urethane 3-(triethoxysilyl)propyl. The free group of the surfactant may be selected from the group consisting of a hydroxyl group, an amine group, or a carboxylic acid group.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of the use of thermally-activated polyurethane (PU) shape memory polymer (SMP) foam hemostatic wound dressings.

FIG. 2 is a diagram of the synthesis of gas-blown of thermally-activated polyurethane (PU) shape memory polymer (SMP) foams.

FIG. 3 is a diagram of the synthesis of surfactants and a Fourier transform infrared spectra used to confirm synthesis according to the present invention for use in, among other things, forming of thermally-activated polyurethane (PU) shape memory polymer (SMP) foams.

FIG. 4 is a diagram of an exemplary surfactant according to the present invention.

FIG. 5 is a series of images of the characterization of thermally-activated polyurethane (PUr) shape memory polymer (SMP) foams formed using surfactants according to the present invention.

FIG. 6 is a series of graph of the characterization of volume recovery of compressed polyurethane (PUr) shape memory polymer (SMP) foams formed using surfactants according to the present invention.

FIG. 7 is a series of images of cytocompatibility studies demonstrating acceptable cell viability for foams made using surfactants according to the present invention.

FIG. 8 is a Fourier transform infrared spectra of foams made with EPH-190 and modified Kolliphor showing that surfactants do not react with PUr system and therefore chemistry of foams should not be impacted.

FIG. 9 is a graph showing that all compressed foams have rapid expansion in 37° C. water, reaching full volume recovery within 1 minute.

FIG. 10 is a series of scanning electron micrographs showing effects of synthesizing PUr foams with methyl formate as a physical blowing agent,

### DETAILED DESCRIPTION

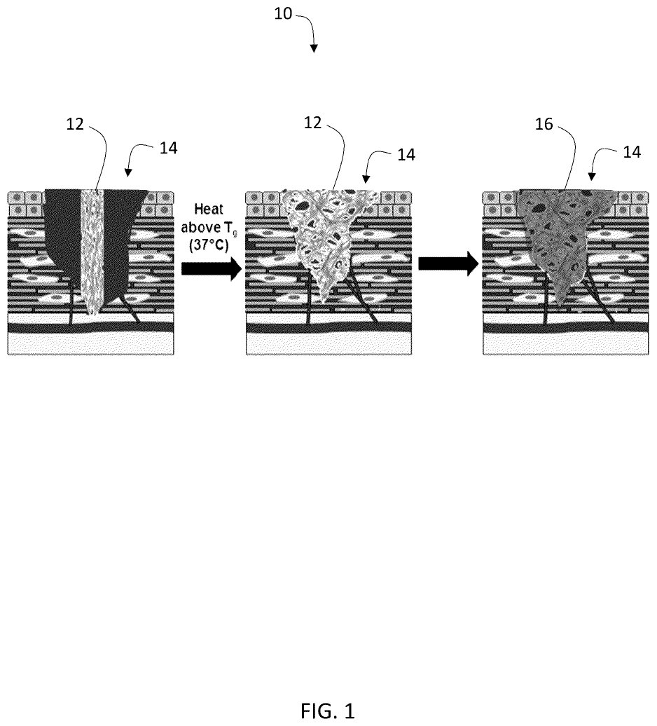

Referring to the figures, wherein like numerals refer to like parts throughout, there is seen in FIG. 1 an approach 10 for using a thermally-activated polyurethane (PUr) shape memory polymer (SMP) foam as an hemostatic wound dressing. First, a foam 12 is compressed from a primary shape into a temporary shape and inserted into a wound site 14. Foam 12 then expands back to its primary shape to fill wound site 14. Finally, foam 12 has induced clotting 16 to assist with healing of the wound site 14.

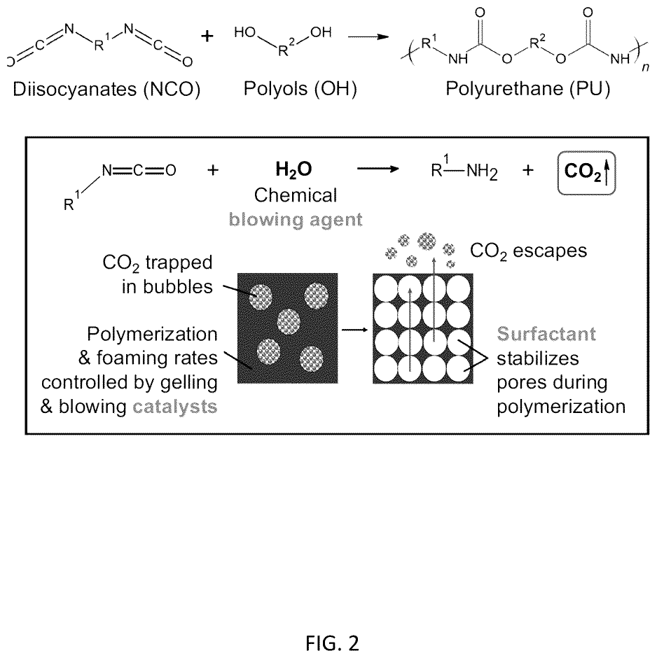

Referring to FIG. 2, there is seen the synthesis of gas-blown thermally-activated polyurethane (PU) shape memory polymer (SMP) foams using diisocyanates and polyols for use as wound dressings. Polymerization and foaming rates are controlled by gelling and blowing catalysts that allow carbon dioxide to be trapped within bubbles formed in the polymer. The carbon dioxide is allowed to escape, with surfactants stabilizing the resulting pores during polymerization.

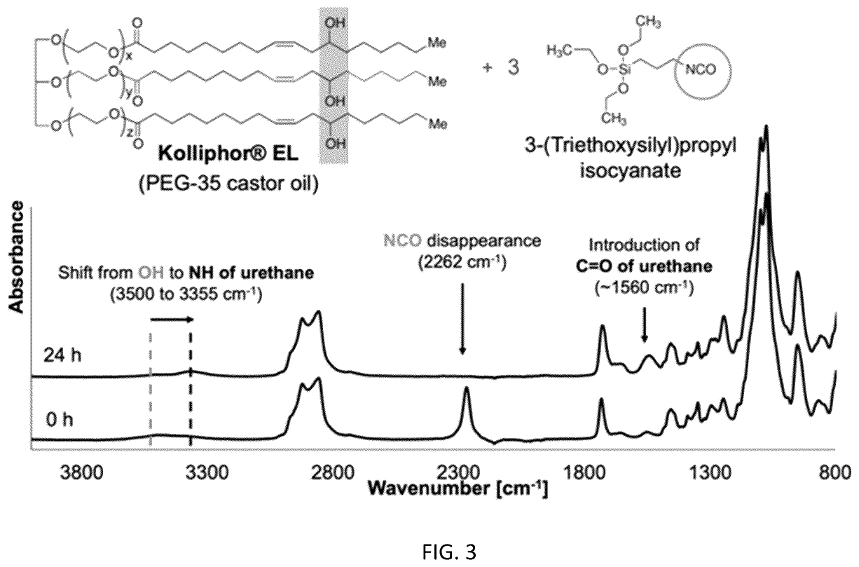

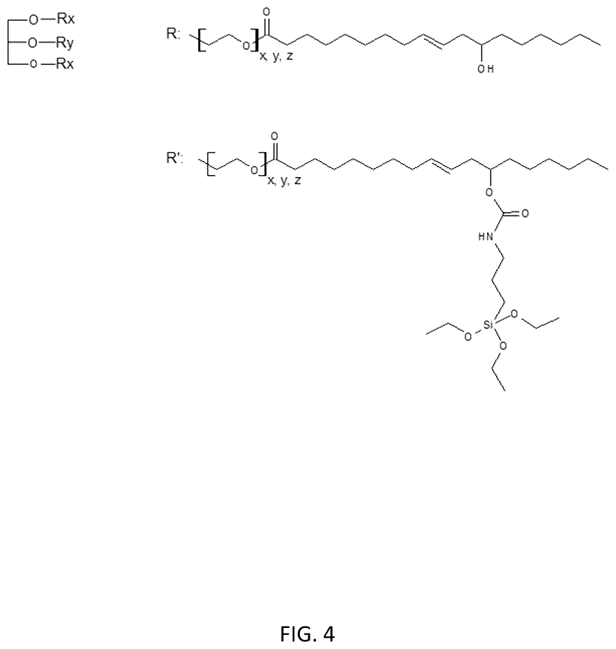

Referring to FIG. 3, commercially available surfactants may be modified according to the present invention for use in the synthesis of polymers foams as seen in FIG. 2. More specifically, a widely available and inexpensive polyethoxylated castor oil (ricinoleic acid triglyceride), such as PEG-35 (non-ionic solubilizer and emulsifier made by reacting castor oil with ethylene oxide in a molar ratio of 1:35) available as KOLLIPHOR® EL from BASF Corp, is modified using 3-(triethoxysilyl)propyl isocyanate to form macroglycerol ricinoleate urethane 3-(triethoxysilyl)propyl. A diagram of the compound is seen in FIG. 4. Any surfactant with a pendant reactive group, which may include hydroxyls, amines, or carboxylic acids, could be used in place of the castor oil described in the structure above. Any small molecule with a single isocyanate group could be used in place of the 3-(triethoxysilyl)propyl isocyanate.

The OH groups of the oil are easily reacted with the isocyanate group to form urethane bonds. No solvents or catalysts are needed for the reaction. The surfactant will not react with the polymer foam to become incorporated in the network, does not change the surface chemistry of the foam, and can be washed out of the foam after synthesis. The surfactant may thus be formed using off-the-shelf components and can be easily removed from the foam after maintaining and controlling foam properties.

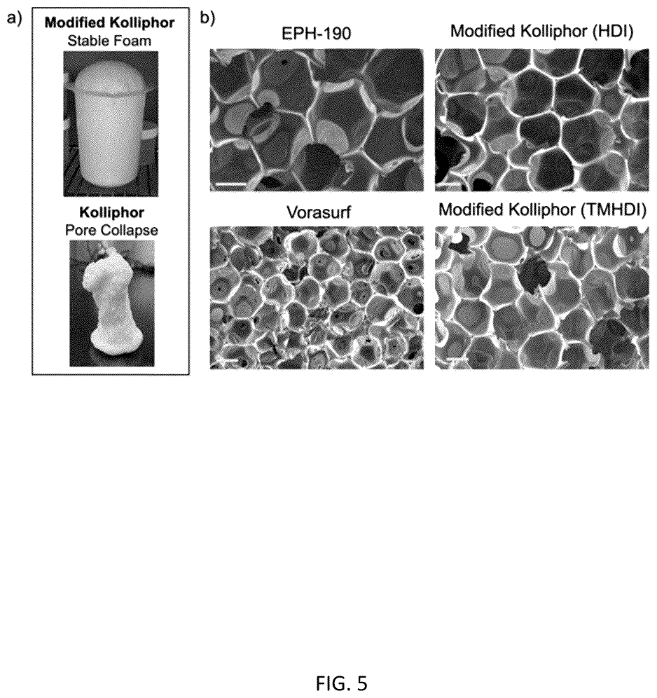

Referring to FIG. 5, exemplary foams formed using surfactants according to the present invention demonstrated superior characteristics. For example, foam synthesized with modified KOLLIPHOR® and commercially available catalysts, such as a 1,4-diazabicyclo[2.2.2]octane (DABCO) as the blowing agent and dibutyltin dilaurate (DBTDL) as the gelling agent demonstrated significantly improved stability of pores as opposed to the use of unmodified KOLLIPHOR®.

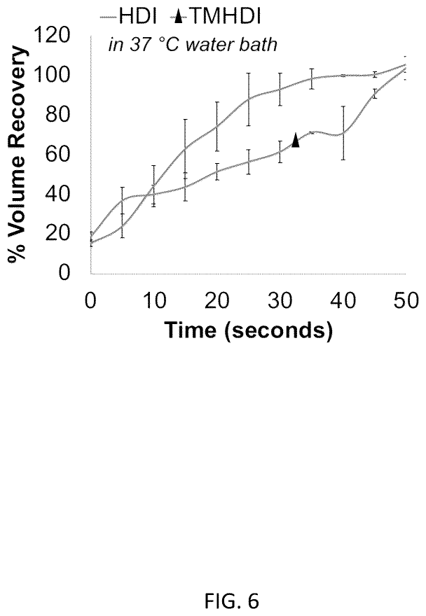

Referring to FIG. 6, the improved pore stability was evident in foams formed using both hexamethylene diisocyanate (HDI) and trimethyl hexamethylene diisocyanate (TMHDI) as the isocyanate component, and both foams demonstrated acceptable pore size, shape fixation and density as well as volume recovery in water.

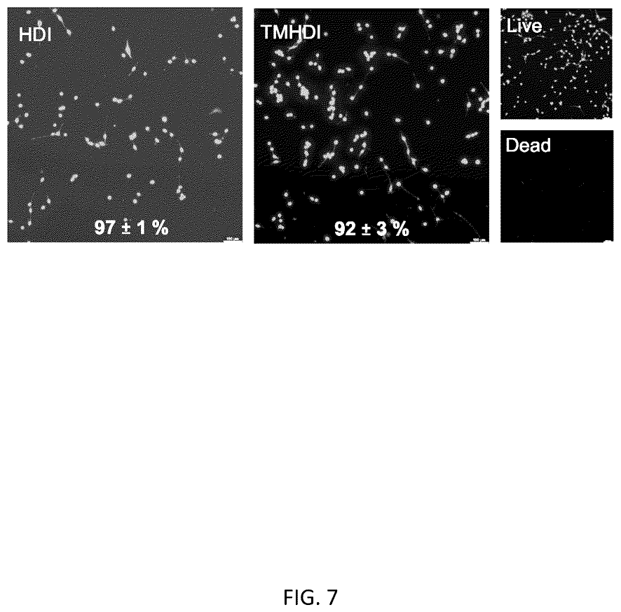

Referring to FIG. 7, exemplary forms formed using surfactants according to the present invention demonstrated acceptable cell viability in cytocompatibility studies.

Surfactants formed according to the present invention from modified KOLLIPHOR® thus stabilize foam pores and can provide polymer foams that meet target criteria for structural, thermal, and shape memory properties. When used with readily available catalysts, modified KOLLIPHOR® therefore provides a completely off-the-shelf synthesis route for SMP foams. The present invention thus allows for the use of entirely off-the-shelf components to enable efforts to broaden access to affordable and effective hemostatic foam dressings.

### Example

### Materials

N,N,N′,N′-tetrakis-(2-hydroxypropyl)-ethylene diamine (HPED), triethanolamine (TEA), hexamethylene diisocyanate (HDI), trimethylhexamethylene diisocyanate (TMHDI), methyl formate, ethanol (reagent alcohol), and dibutyltin dilaurate (DBTDL) were purchased and used as received from Fisher Scientific (Waltham, MA). DABCO 33 LV, KOLLIPHOR® EL, and 3-(Triethoxysilyl)propyl isocyanate were purchased and used as received from Sigma-Aldrich (St. Luis, MO). VORASURF™ DC 198 was purchased and used as received from Dow (Midland, MI). Phosphate buffered saline (PBS), Dulbecco's modified Eagle's medium (DMEM), penicillin-streptomycin (P/S), and fetal bovine serum (FBS) were purchased from Thermo Fisher Scientific (Waltham, MA) and used as received.

### Modification of KOLLIPHOR®

KOLLIPHOR® was modified by reacting it at a 1:3 ratio with 3-(triethoxysilyl)propyl isocyanate to cap the free hydroxyls to prevent surfactant reaction with NCO groups during foam synthesis. Briefly, KOLLIPHOR® and the isocyanate were weighed and added to a round bottom flask inside a precise controlled atmosphere glove box. The flask was sealed, moved to an oil bath, and reacted under nitrogen and constant stirring (300 rpm) at 50° C. for 24 h.

### Spectroscopic Analysis

Fourier transform infrared spectroscopy was used to check reaction completion (shift in OH peak ~3500 to NH of urethane ~3350 cm⁻¹, disappearance of NCO at ~2260 cm⁻¹, introduction of C—O of urethane at ~1560 cm⁻¹). Chemical composition was confirmed using nuclear magnetic resonance spectroscopy. FTIR was also used to characterize the surface chemistry of the resulting foams at 4 cm⁻¹ resolution. Spectra of each sample were generated via OMNIC software (Fischer Scientific, Waltham, MA) as an average of 16 scans.

### Foam Synthesis

An isocyanate (NCO) pre-polymer mix was prepared inside the glove box with 0.35 hydroxyl (OH) molar equivalents (HPED and TEA) and 1 NCO molar equivalent (HDI). This was high-speed mixed for 30 s and reacted in an oven at 50° C. for 48 h. After 48 h, surfactant (modified KOLLIPHOR® or VORASURF™) was added to the NCO mix in varied wt % to determine the volume needed to stabilize pores without foam collapse. The remaining 0.65 molar equivalents of OH were combined with deionized (DI) water and catalysts (DBTDL and DABCO 33 LV) in a separate container and high-speed mixed for 30 s. The OH mix and NCO premix were then combined and mixed for 5 s at 1800 rpm. The mixture was poured into a 400 ml cylindrical mold and set to foam in a 50° C. oven for 10 min.

The modified KOLLIPHOR® surfactant was also used in foams made with TMHDI to assess its use in various isocyanate systems. Only foams that resulted in a stable foam (i.e., did not collapse) were characterized. Foams were washed in DI water and 70% ethanol to remove surfactant and catalysts prior to all analysis. After determining the ideal wt % of surfactant for maintaining control foam properties, methyl formate was incorporated as a physical blowing agent during foam synthesis to provide foams with a range of pore interconnectivities.

### Foam Pore Analysis

Foam sections ~1 cm² were cut from the top, middle, and bottom of the foams along both parallel and perpendicular axes relative to the foam rise direction (n=6 per foam formulation). Samples were coated with gold for 45 s using a Denton high vacuum sputter coater. Pore morphology was characterized using JEOL JSM 5600 scanning electron microscope (SEM) under 10 kV high vacuum at 25× magnification. SEM images were analyzed using ImageJ to quantify pore size.

### Thermal Analysis

Q200 differential scanning calorimeter (DSC, TA instruments) was used to measure the dry glass transition temperature (Tg) of 3-5 mg samples (n=3). Samples were equilibrated at −40° C., heated to 120° C. at 10° C./min, held isothermally for 2 min, cooled to −40° C. at 10° C./min, then heated to 120° C. at 10° C./min. The half-height transition of the inflection point in the second heating cycle was used to determine the dry Tg.

### Density

Cylindrical foam samples (n=3, ~1 cm length, 8 mm diameter) were prepared using a biopsy punch and weighed. Length and diameter measurements were taken using digital calipers and used to calculate density (mass/volume) in their expanded conformations.

### Shape Memory Analysis

Cylindrical punches prepared above were used to determine shape fixity and volume recovery. Briefly, samples were heated to 70° C. for 15 min before radial crimping under constant load and allowed to cool to room temperature. Length and diameter of the samples were measured directly after crimping and 24 h later to determine % shape fixity. After reprogramming, samples were submerged in a water bath at 37° C. A camera was used to record dynamic volume changes, and ImageJ was used to determine % volume recovery over 5 minutes.

### Cytocompatibility

NIH/3T3 Swiss mouse fibroblasts (ATCC-CCL92) were cultured using DMEM supplemented with 10% FBS and 1% P/S at 37° C./5% CO₂ to ~100% confluency. The cells were passaged and seeded onto a 24-well tissue culture plate at 10,000 cells/well. Sterile foam punches (6 mm diameter, 1 mm thickness, n=3) were added to the pre-seeded 24-well plates to incubate for 24 h. Then, foam samples were removed and Live/Dead® assay (ThermoFisher Scientific) was used to confirm cell survival with an inverted fluorescent microscope. A positive control (no sample) and negative control (30% H₂O₂) were also imaged.

### Statistical Analysis

ANOVA with Tukey's post hoc test was used to compare differences in material properties of control PUr foams synthesized with the old (EPH-190) and new (modified KOLLIPHOR® and VORASURF™) surfactants. Statistical significance was taken at p<0.05.

Surfactant Synthesis: The reaction of Kolliphor with 3-(triethoxysilyl)propyl NCO resulted in a modified surfactant without free-OH groups. It is a simple, solvent- and catalyst-free reaction with ~100% yield. FTIR showed the disappearance of the NCO peak at 2262 cm⁻¹ at 24 h, indicating reaction completion, see FIG. 3, and the product was confirmed with NMR.

Foam characterization: The modified Kolliphor and Vorasurf surfactants were added during foam synthesis in varying wt % to determine the optimal amount for pore stabilization. After stabilizing pores, the volume of gelling and blowing catalysts were adjusted accordingly to achieve the desired pore size, i.e., without a statistically significant difference compared to our previous control foam. When added in the same wt % as the modified Kolliphor, the unmodified Kolliphor resulted in pore collapse, see FIG. 5(a), confirming the need to cap the free OH groups. SEM micrographs confirmed that the modified Kolliphor resulted in stable, uniform pores with both HDI and TMHDI, demonstrating its use as a stabilizer across various NCO systems, see FIG. 5(b).

After achieving the desired pore structure, the remaining material properties were analyzed. Table 1 summarizes the target criteria based on our previous control PUr foams made with the single-supplier surfactant and catalysts (EPH-190, T-131, and BL-22), and a comparison of the resulting foam properties made with the alternative surfactants.

TABLE 1
Summary of material properties of foams synthesized with
EPH-190 (discontinued), modified Kolliphor (used with
both NCOs, HDI and TMHDI), and Vorasurf surfactants.

| | | EPH-190 | Modified Kolliphor | | |
|---|---|---|---|---|---|
| | | (previous | NCO: | NCO: | |
| | Target | control) | HDI | TMHDI | Vorasurf |
| Pore Size (μm) | ~1000 | 1160 ± 300 | 1200 ± 120 | 1100 ± 200 | 940 ± 200 |
| Dry Tg (° C.) | >50 | 52 ± 1 | 43 ± 2 * | 56 ± 2 | 56 ± 2 |
| 24 h shape fixity (%) | >80 | 83 ± 10 | 81 ± 10 | 98 ± 2 | 86 ± 2 |
| Density (g/cm³) | <0.1 | 0.06 ± 0.01 | 0.05 ± 0.01 | 0.05 ± 0.00 | 0.06 ± 0.00 |
| 24 h | >70 | 97 ± 2 | 97 ± 1 | 92 ± 3 | 97 ± 1 |
| cytocompatibility (%) | | | | | |

* p < 0.05 vs. EPH-190.

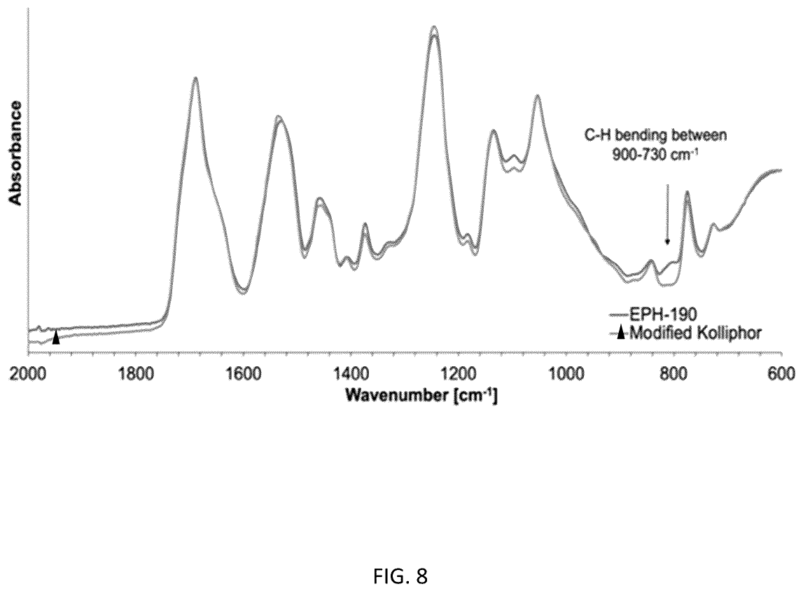

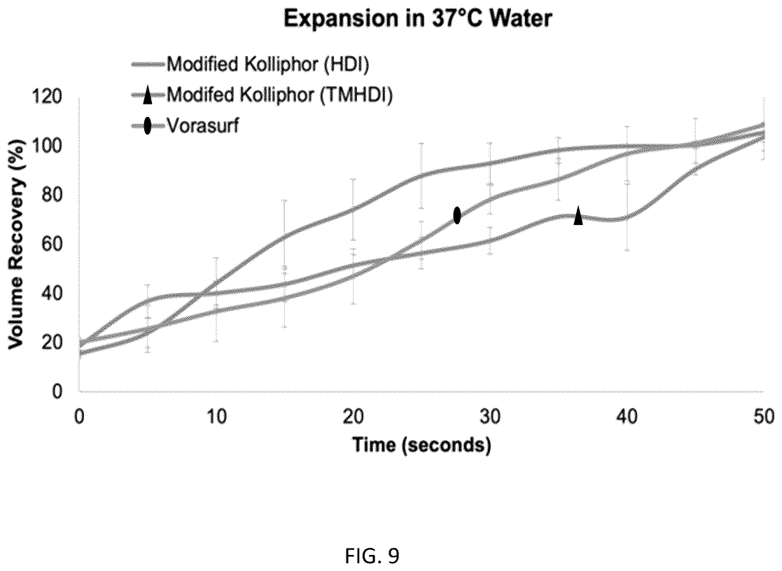

The target dry Tg is >50° C. to enable stable, dry storage in foam secondary shape under extreme temperatures. The HDI foam made with modified Kolliphor falls short of this criterion and is significantly different from our previous control PUr (p=0.009) which could be explained by slight differences in FTIR spectra, see FIG. 8. Whereas, the TMHDI foam had higher Tg (56° C.) due to decreased chain flexibility with added bulky methyl groups. The hydrophobic methyl groups also improved shape fixity by reducing interactions with ambient moisture. That said, both HDI and TMHDI foams have a wet Tg below body temperature (22° C. and 27° C., respectively) which allows for rapid shape recovery when exposed to body-temperature blood. This was confirmed in FIG. 9 showing rapid expansion and 100% volume recovery of both foams within 1 minute in body temperature water.

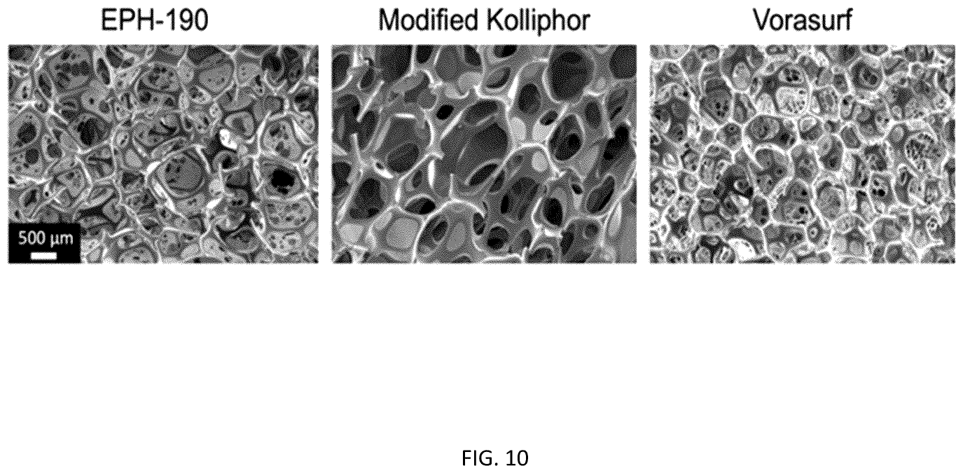

Both foams are also highly cytocompatible (97% and 92% for HDI and TMHDI, respectively), meeting the ISO 10993 standard of >70% cell viability, confirming that the surfactant is easily washed out. The foams also maintain the target criterion for low density (<0.1 g/cm³), allowing them to be easily crimped a stored in a low-profile shape. The Vorasurf surfactant maintained all target criteria with no statistically significant differences compared to EPH-190, confirming it is a good substitute for the discontinued surfactant. When methyl formate was added as a physical blowing agent during foam synthesis, the resulting pore structure varied greatly across foams made with the modified Kolliphor surfactant compared to EPH-190 and Vorasurf, see FIG. 10. The Vorasurf foam pores were comparable to previous work, with pore openings in the shape of pinholes within pore membranes. On the other hand, the modified Kolliphor foam had large holes within membranes, inconsistent pore sizes, and slight pore collapse. This could imply that Vorasurf is a stronger surfactant.

The modified Kolliphor is an easy-to-synthesize surfactant that stabilizes foam pores during foam fabrication. When combined with the readily available catalysts and blowing agents, it allows for a completely off-the-shelf synthesis route for our control PUr foams, which can greatly improve future commercialization efforts. That said, we had better control over tuning pore interconnectivity with Vorasurf and maintained Tg>50° C. with HDI (our control PUr foam NCO), so it may be useful in further studies to understand the role that pore structure of PUr foams has in healing.

What is claimed is:

1. A pore stabilizer for use in polymer foam formation, comprising a surfactant having a free group reacted with an isocyanate to form a urethane bond.

2. The pore stabilizer of claim 1, wherein the surfactant comprises polyethoxylated ricinoleic acid triglyceride.

3. The pore stabilizer of claim 1, wherein the isocyanate is 3-(triethoxysilyl)propyl isocyanate.

4. The pore stabilizer of claim 1, wherein the pore stabilizer is macroglycerol ricinoleate urethane 3-(triethoxysilyl)propyl.

5. The pore stabilizer of claim 1, wherein the free group of the surfactant is selected from the group consisting of a hydroxyl group, an amine group, and a carboxylic acid group.

6. A method of forming a thermally-activated polyurethane shape memory polymer foam, comprising the step of reacting a diisocyanate with a polyol to form a polyurethane in the presence of a blowing agent and the pore stabilizer of claim 1.

7. The method of claim 6, wherein the pore stabilizer comprises an amount of polyethoxylated ricinoleic acid triglyceride reacted with an amount of second isocyanate.

8. The method of claim 7, wherein the pore stabilizer is macroglycerol ricinoleate urethane 3-(triethoxysilyl)propyl.

9. The method of claim 8, wherein the polyol is a polyether polyol, poly(propylene glycol), N,N,N′,N′-tetrakis-(2-hydroxypropyl)-ethylene diamine, triethanolamine, or a sucrose/glycerine initiated polyether polyol.

10. The method of claim 8, wherein the diisocyanate is hexamethylene diisocyanate, trimethyl hexamethylene diisocyanate, diphenylmethane-4,4-diisocyanate, or isophorone diisocyanate.

11. A method of forming a pore stabilizer, comprising the steps of:
providing a surfactant having a free group; and
reacting the surfactant with an isocyanate to form a urethane bond at the free group.

12. The method of claim 11, wherein the surfactant comprises polyethoxylated ricinoleic acid triglyceride.

13. The method of claim 11, wherein the isocyanate is 3-(triethoxysilyl)propyl isocyanate.

14. The method of claim 11, wherein the surfactant is macroglycerol ricinoleate urethane 3-(triethoxysilyl)propyl.

15. The method of claim 11, wherein the free group of the surfactant is selected from the group consisting of a hydroxyl group, an amine group, and a carboxylic acid group.
